(19) United States
(12) Patent Application Publication
(10) Pub. No.: US 2019/0011913 A1
(43) Pub. Date: Jan. 10, 2019

(54) METHODS AND SYSTEMS FOR BLIND SPOT DETECTION IN AN AUTONOMOUS VEHICLE

(71) Applicant: GM GLOBAL TECHNOLOGY OPERATIONS LLC, Detroit, MI (US)

(72) Inventor: Kevin Chu, San Mateo, CA (US)

(73) Assignee: GM GLOBAL TECHNOLOGY OPERATIONS LLC, Detroit, MI (US)

(21) Appl. No.: 15/641,869

(22) Filed: Jul. 5, 2017

(51) Int. Cl. G05D 1/00; G01C 21/30; G01S 17/93; G01S 13/93; G05D 1/02

(52) U.S. Cl. CPC G05D 1/0055; G01C 21/30; G01S 17/936; G01S 13/931; G05D 2201/0213; G05D 1/0246; G01S 2013/9332; G01S 2013/9346; G05D 1/0274

(57) ABSTRACT

Systems and method are provided for controlling a vehicle. In one embodiment, a method includes: receiving, by a processor, sensor data sensed from an environment of the vehicle; processing, by the processor, the sensor data to determine a blind spot of the environment of the vehicle; setting, by the processor, an operation mode of the vehicle to a caution mode based on the determined blind spot; and controlling, by the processor, operation of the vehicle based on the operation mode.

### TECHNICAL FIELD

The present disclosure generally relates to autonomous vehicles, and more particularly relates to systems and methods for detecting blind spots and controlling the autonomous vehicle based thereon.

### INTRODUCTION

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Higher level automation relies on sensor data to “see” the surrounding areas as a driver would see them. When the sensors are unable to see an area due an obstacle obstructing the view, this is referred to a blind spot. When a blind spot occurs, it is undesirable for the autonomous vehicle to sit and do nothing.

Accordingly, it is desirable to provide systems and methods that detect blind spots and to control the autonomous vehicle based thereon. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a vehicle. In one embodiment, a method includes: receiving, by a processor, sensor data sensed from an environment of the vehicle; processing, by the processor, the sensor data to determine a blind spot of the environment of the vehicle; setting, by the processor, an operation mode of the vehicle to a caution mode based on the determined blind spot; and controlling, by the processor, operation of the vehicle based on the operation mode.

In one embodiments, a computer-readable medium includes computer-executable instructions stored thereon that, when executed by a processor of a controller onboard the vehicle, cause the processor to perform the method.

In one embodiment, the vehicle is an autonomous vehicle. The autonomous vehicle includes at least one sensor that provides sensor data sensed from an environment of the autonomous vehicle and a controller. The controller, by a processor, receives the sensor data, processes the sensor data to determine a blind spot of the environment of the vehicle, sets an operation mode of the autonomous vehicle to a caution mode based on the determined blind spot, and controls operation of the autonomous vehicle based on the operation mode.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a blind spot detection system, in accordance with various embodiments;

FIG. 2 is a functional block diagram illustrating a transportation system having one or more autonomous vehicles of FIG. 1, in accordance with various embodiments;

FIGS. 3 and 4 are dataflow diagrams illustrating an autonomous driving system that includes the blind spot detection system of the autonomous vehicle, in accordance with various embodiments; and

FIG. 5 is a flowchart illustrating a control method for controlling the autonomous vehicle according, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

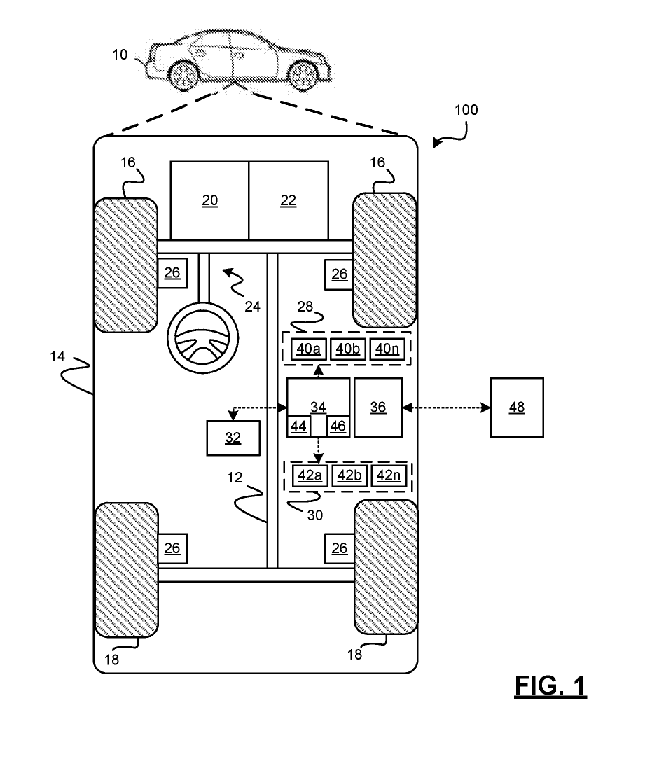

With reference to FIG. 1, a blind spot management system shown generally at 100 is associated with a vehicle 10 in accordance with various embodiments. In general, the blind spot management system 100 determines that the vehicle cannot see enough of its surroundings (blind spots) and intelligently controls the vehicle 10 based thereon.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the blind spot management system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

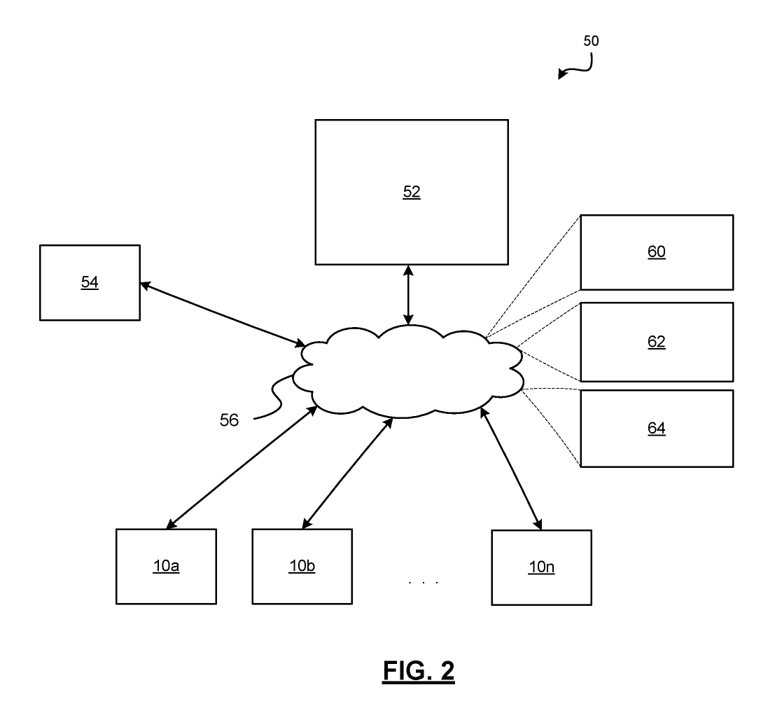

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the blind spot management system 100 and, when executed by the processor 44, evaluate an area associated with the upcoming path of the vehicle 10 and control the vehicle 10 based thereon. The instructions evaluate the area associated with the path of the vehicle to determine if the area includes space that is undetectable (e.g., because of an obstacle blocking the view). For example, the instructions evaluate onboard sensor information associated with the area associated with the upcoming path of the vehicle 10 to determine if the upcoming area includes space that is clear, includes space that has an obstacle, or includes space that is not clear and does not include an obstacle. If the space in the area is clear, control signals are generated to control the vehicle 10 according to the planned path. If the space in an area includes an obstacle and the obstacle is in the planned path, control signals are generated to stop the vehicle 10 or navigate around the obstacle. If the area includes a space that is not clear or unknown but an obstacle is not detected in the planned path, control signals are generated to cause the vehicle 10 to approach the path associated with the space cautiously. For example, control signals are generated to control the vehicle to slowly move or creep forward along the path. The control signals are generated until it is determined that the space in the area is clear (in which case the default mode is entered) or includes an obstacle in the path (in which case the stop mode is entered).

In various embodiments, locations of known blind corners or known areas that have been indicated to create blind spots for the sensor system 28 are maintained by the controller 34 and the instructions, when executed by the processor, evaluate the locations with respect to a current location of the vehicle 10 and generate control signals based on the evaluation. For example, control signals are generated to control the vehicle to slowly move or creep in a direction when the vehicle location is at or approaching the known blind corner or the known area that has been indicated to create blind spots.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

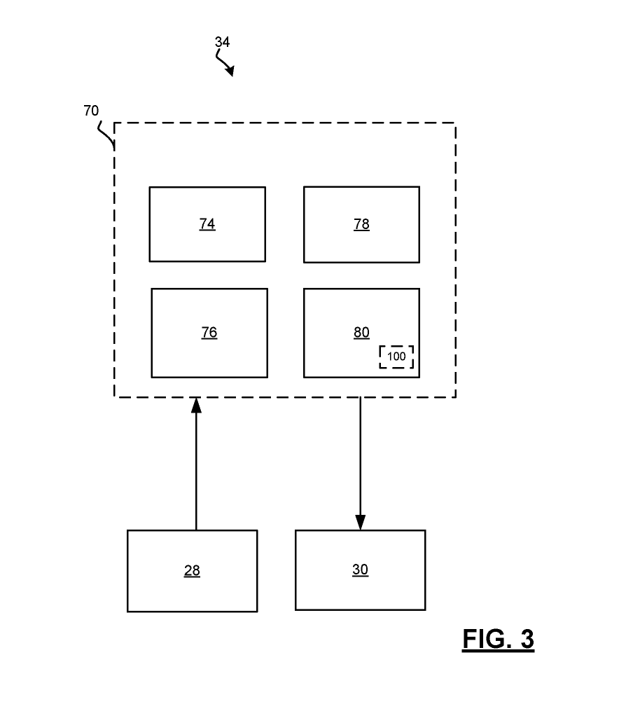

Referring now to FIG. 3, and with continued reference to FIG. 1, a functional block diagram illustrates various embodiments of an autonomous driving system (ADS) 70 which may be embedded within the controller 34 and which may include parts of the blind spot management system 100 in accordance with various embodiments. That is, suitable software and/or hardware components of controller 34 (e.g., processor 44 and computer-readable storage device 46) are utilized to provide an autonomous driving system 70 that is used in conjunction with the autonomous vehicle 10.

In various embodiments, the instructions of the autonomous driving system 70 may be organized by function or system. For example, as shown in FIG. 3, the autonomous driving system 70 can include a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like

As mentioned briefly above, the blind spot management system 100 of FIG. 1 is included within the autonomous driving system 70, for example, as part of the vehicle control system 80. For example, the vehicle control system 80 detects blind spots and controls operation of the vehicle 10 based on the detection. In particular, of the vehicle control system 80 receives the path planning information localization and mapping information and determines a vehicle mode of operation. In various embodiments, the vehicle mode of operation can include, but is not limited to, a default mode, a stop mode, and a caution mode. The vehicle control system 80, when in the stop mode or the caution mode, generates control outputs; and when in the default mode, permits conventional control outputs to be generated.

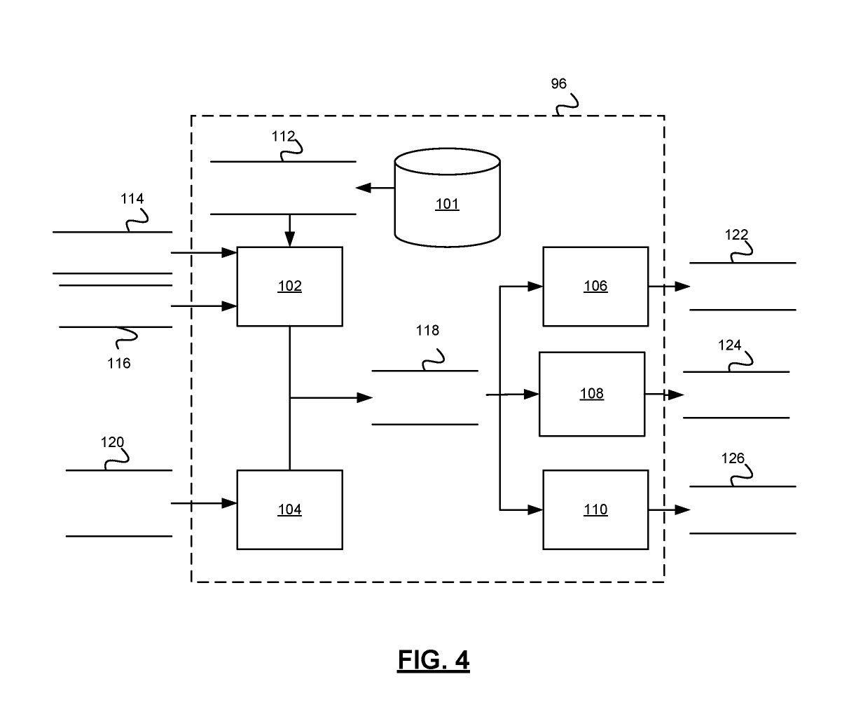

For example, as shown in more detail with regard to FIG. 4 and with continued reference to FIG. 3, the blind spot management system 100 includes a blind area map datastore 101, a first blind area detection module 102, a second blind area detection module 104, a caution mode control module 106, a stop mode control module 108, and a default mode control module 110.

The blind area map datastore 101 stores map information 112. The map information 112 includes maps of various areas and indications of locations within the map of known blind corners and/or areas of interest. The blind corners and areas of interest can be predefined (e.g., defined by a user of the remote access center 97 and communicated to the vehicle 10) and/or learned over time (e.g., learned when the caution mode is enabled at a particular location X number of times, or other method of learning) by the vehicle 10 or other vehicles 10a-10n.

The first blind area detection module 102 receives the vehicle location output 114 that indicates a vehicle location and a path planning output 116 that indicates a vehicle path. Based on the vehicle location and vehicle path, the first blind area detection module 102 determines a vehicle operation mode 118. For example, the first blind area detection module 102 retrieves the map information 112 from the blind area map datastore 101 based on the vehicle path. The first blind area detection module 102 retrieves the map information 112 associated with the upcoming vehicle path. Thereafter, the first blind area detection module 102 compares the current vehicle location as indicated by the vehicle location output 114 with the map information 112 to determine if the current vehicle location is at or about to approach a known blind corner or a known area of interest. If the current vehicle location is at or about to approach a known blind corner or a known area of interest, the vehicle operation mode 114 is changed to the caution mode. If the current vehicle location is not at or not about to approach a known blind corner or a known area of interest, the vehicle operation mode is maintained as the default mode.

The second blind area detection module 104 receives a localization and mapping output 120 that indicates obstacles (e.g., detected objects in contact with the ground) and free space (e.g., space without obstacles from the ground up) detected in an area associated with the upcoming path. Depending on the type of the sensor that generates the sensor data, there are multiple methods of determining freespace, obstacles, and blind spots. For example, from image camera data, it can be determined with high levels of confidence where the road free space exists; however, it cannot be determine whether an occlusion is due to an obstacle or other unknown reasons. In another example, from lidar data, obstacles and free space can be determined by determining the nature of the return (whether it be off the ground plane or not). When a no return is received, where it is ambiguous on whether the angle of incidence on the road is too large or reflectivity too poor to get a strong signal back, an unknown or blind spot can be determined. In still another example, from radar data the lack of signal is not confident enough to determine whether the space in the direction of the radar is free. As such, the radar data can be used to determine obstacles.

The second blind area detection module 104 evaluates the obstacles and free space to determine if a defined space of an area associated with the path of the vehicle 10 is clear or includes free space or if a defined space includes one or more obstacles. The defined space can be the space in front of the vehicle, the space in front of and to the left of the vehicle (if the path indicates a right turn is planned), in front of the and two the right of the vehicle (if the path indicates a left turn), etc.

In various embodiments, the defined space can be determined based on historical behaviors. For example, additional post processing can take into account additional information from the vehicle 10 to account for sudden obstacles or risk factors that are common such as, but not limited to, a pedestrian coming from around or fast moving cars coming from around blind corners. In the first example, using the map information 112, the second blind area detection module 104 can acknowledge the fact that this is a residential zone. With this information, the second blind area detection module 104 can expand the defined area and/or the blind spot around parked cars to spread, causing additional areas of caution. In the second example, similarly, using the map information 112 about the speed of lanes in intersections the second blind area detection module 104 post processes the unknown free space to account for a degree of caution required for the vehicle 10. For example, a slow moving residential area blocked on the far corner would not invoke a large spread of the defined space or blind spot of caution. However, at a fast moving intersection where the blind spot is close, the spread will be rather large, and trigger a much more cautioned response.

Once the defined space is determined, the second blind area detection module 104 evaluates the defined space. For example, if the defined space is clear, then the second blind area detection module 104 sets the vehicle operation mode 118 to the default mode. In various embodiments, if the defined space is not clear, the second blind area detection module 104 determines whether the defined space includes an obstacle in the path of the vehicle 10. If the defined space includes an obstacle in the path of the vehicle 10, the second blind area detection module 104 sets the vehicle operation mode 118 to the stop mode. In still another example, if a clear obstacle is not detected in the defined space, but free space is still undetectable in the defined space, the vehicle operation mode 118 is changed to or maintained in the caution mode.

The caution mode control module 106 receives as input the vehicle operation mode 118. The caution mode control module 106 selectively generates control signals 122 that are communicated to the actuator system 30 based on the values of the vehicle operation mode 118. For example, when the vehicle operation mode 118 is the caution mode, the caution mode control module 106 generates the control signals 122 to control the speed and acceleration of the vehicle 10 to slowly move forward. For example, the selected speed and acceleration relates to a safe deceleration rate given a “surprise” obstacle. In another example, when the vehicle operation mode 118 is the default mode or the stop mode, the caution mode control module 105 does not generate any moving control signals 122.

The stop mode control module 108 receives as input the vehicle operation mode 118. The stop mode control module 108 selectively generates control signals 124 that are communicated to the actuator system 30 based on the values of the vehicle operation mode 118. For example, when the vehicle operation mode 118 is the stop mode, the stop mode control module 108 generates the control signals 124 to control the speed and acceleration of the vehicle 10 to at or near zero, to stop the vehicle 10. In another example, when the vehicle operation mode 118 is the default mode or the caution mode, the stop mode control module 108 does not generate any control signals 124.

The default mode control module 110 receives as input the vehicle operation mode 118. The default mode control module 110 selectively generates an enable signal 126 that is communicated to the first control module 92 based on the values of the vehicle operation mode 118. For example, when the vehicle operation mode 118 is the default mode, the default mode control module 110 generates the enable signal 126 to enable default control of the vehicle 10 as performed by the vehicle control system 80. In another example, when the vehicle operation mode 118 is the stop mode or the caution mode, the default mode control module 110 generates a disable signal 126 to disable default control of the vehicle 10 as performed by the vehicle control system 80.

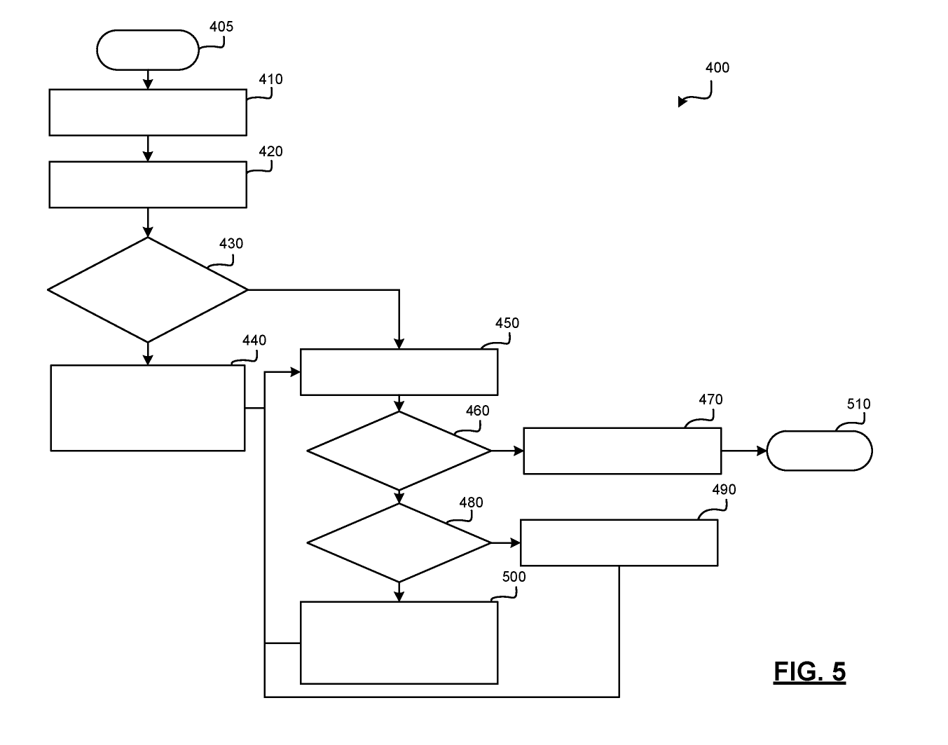

Referring now to FIG. 5, and with continued reference to FIGS. 1-4, a flowchart illustrates a control method 400 that can be performed by the blind spot management system 100 of FIG. 1 in accordance with the present disclosure. As can be appreciated in light of the disclosure, the order of operation within the method is not limited to the sequential execution as illustrated in FIG. 4, but may be performed in one or more varying orders as applicable and in accordance with the present disclosure. In various embodiments, the method 400 can be scheduled to run based on one or more predetermined events, and/or can run continuously during operation of the autonomous vehicle 10.

In various embodiments, the method may begin at 405. The vehicle location output 114 and the path planning output 116 are received at 410. The map information 112 of known blind corners and areas of interest is retrieved based on the path at 420. The vehicle location is compared with the map information 112 to determine if the vehicle location is at or about to approach a known blind corner or a known area of interest at 430. If the current vehicle location is at or about to approach a known blind corner or a known area of interest at 430, the vehicle operation mode 118 is set to the caution mode and the control signals 122 are automatically generated to control the vehicle movement according to the slow or creep forward maneuver at 440.

Thereafter, the sensor data is received and processed at 450-500. For example, the sensor data is received at 450 and processed to determine if the defined space associated with the path of the vehicle 10 is clear or includes free space at 460. If the defined space is clear, then the vehicle operation mode 118 is set to the default mode and control signals are generated to control the speed and acceleration of the vehicle 10 according to the normal mode of operation at 470. Thereafter, the method may end at 510.

If, however, at 460, the defined space is not clear, it is determined whether the defined space includes an obstacle in the path of the vehicle 10 at 480. If the defined space includes an obstacle in the path of the vehicle 10 at 480, the vehicle operation mode 118 is set to the stop mode and control signals 124 are generated to control the speed and acceleration of the vehicle 10 to at or near zero at 490. Thereafter, the method continues at 450 where new sensor data is received and processed. In such case, the method continues until the obstacle has moved and free space is detected at 460, the vehicle operation mode 118 is changed back to the default mode at 470, and the method ends at 510.

If, at 480, a clear obstacle is not detected in the path of the vehicle 10, but free space is still undetectable, the vehicle operation mode 118 is changed or maintained in the caution mode and the control signals 98 are generated to control the vehicle movement according to the slow or creep forward maneuver at 440. Thereafter, the method continues at 450 where new sensor data is received and processed. In such case, the method continues until the free space is detected at 460, the vehicle operation mode 114 is changed back to the default mode at 470, and the method ends at 510.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle, comprising:
receiving, by a processor, sensor data sensed from an environment of the vehicle;
processing, by the processor, the sensor data to determine a blind spot of the environment of the vehicle;
setting, by the processor, an operation mode of the vehicle to a caution mode based on the determined blind spot; and
controlling, by the processor, operation of the vehicle based on the operation mode.

2. The method of claim 1, wherein when in the caution mode, the controlling comprises generating control signals to control at least one of the speed and the acceleration of the vehicle.

3. The method of claim 1, wherein the control signals control the at least one of speed an acceleration of the vehicle based on a creep forward method.

4. The method of claim 1, wherein the control signals control the at least one of speed an acceleration of the vehicle based on a degree of caution determined from at least one of a location and vehicle information.

5. The method of claim 1, wherein the processing the sensor data to determine a blind spot comprises:
defining an area associated with a path of the vehicle, and
evaluating the sensor data in the defined area.

6. The method of claim 5, wherein the defining the area is based on at least one of common obstacles and risk factors.

7. The method of claim 5, wherein the evaluating the sensor data comprises evaluating the sensor data for at least one of space that is clear, space that is not clear, and an obstacle.

8. The method of claim 1, further comprising receiving a localization of the vehicle, and wherein the setting the operation mode of the vehicle to the caution mode is based on the localization.

9. The method of claim 8, wherein the setting the operation mode of the vehicle is further based on a comparison of the localization to a map of defined blind spot areas.

10. The method of claim 9, wherein the defined blind spot areas are pre-defined.

11. The method of claim 9, wherein the defined blind spot areas are learned.

12. The method of claim 1, further comprising setting the operation mode of the vehicle to default mode based on determined free space.

13. The method of claim 1, further comprising setting the operation mode of the vehicle to a stop mode based on a determined obstacle.

14. The method of claim 1, wherein the sensor data is from a least one of lidar, radar, and camera.

15. The method of claim 1, wherein the processing the sensor data to determine the blind spot comprises determining that an area associated with the path of the vehicle includes space that is undetectable.

16. A computer-readable medium having computer-executable instructions stored thereon that, when executed by a processor of a controller onboard the vehicle, cause the processor to perform the method of claim 1.

17. An autonomous vehicle, comprising:
at least one sensor that provides sensor data sensed from an environment of the autonomous vehicle; and
a controller that, by a processor, receives the sensor data, that processes the sensor data to determine a blind spot of the environment of the vehicle, sets an operation mode of the autonomous vehicle to a caution mode based on the determined blind spot, and controls operation of the autonomous vehicle based on the operation mode.

18. The autonomous vehicle of claim 17, wherein the controller determines the blind spot by: defining an area associated with a path of the vehicle, and evaluating the sensor data in the defined area.

19. The autonomous vehicle of claim 18, wherein the controller defines the area based on at least one of common obstacles and risk factors.

20. The autonomous vehicle of claim 17, wherein the controller determines the blind spot by determining that an area associated with the path of the vehicle includes space that is undetectable.
